(19) United States
(12) Patent Application Publication
(10) Pub. No.: US 2026/0276836 A1
(43) Pub. Date: Sep. 17, 2026

(54) GLOBAL NAVIGATION SATELLITE SYSTEM SPOOFING DETECTION USING WEATHER RADAR DATA

(71) Applicant: Honeywell International Inc., Charlotte, NC (US)

(72) Inventors: Karthikeyan Mariappan, Madurai (IN); Gobinathan Baladhandapani, Madurai (IN)

(21) Appl. No.: 19/213,609

(22) Filed: May 20, 2025

(30) Foreign Application Priority Data
Mar. 11, 2025 (IN) 202511021710

(51) Int. Cl. G01S 19/21; G01S 13/86; G01S 13/95

(52) U.S. Cl. CPC G01S 19/215; G01S 13/86; G01S 13/953

(57) ABSTRACT

A global navigation satellite system spoofing detection system is configured to receive, via a receiver device of the satellite-based navigation system, location data; determine an expected future location of the vehicle based on the location data; receive, from an external computing device via a communication link, first weather data; determine, based on the first weather data, a first weather event for the expected future location; determine, based on second weather data received from a weather radar onboard the vehicle, a second weather event; determine a correlation between the first weather event and the second weather event; and in response to the correlation between the first weather event and the second weather event failing to satisfy a threshold, output an indication that the location data received by the receiver device of the satellite-based navigation system is inaccurate.

This application claims the benefit of Indian Provisional Patent Application No. 202511021710, filed Mar. 11, 2025, the entire contents of which are incorporated herein by reference.

### TECHNICAL FIELD

The disclosure relates to operation of global navigation satellite systems (GNSS) receiver systems.

### BACKGROUND

Global navigation satellite systems (GNSSs) are systems that may include a satellite constellation that provides positioning, navigation, and timing (PNT) services on a global or regional basis. Some examples of GNSSs include the global positioning system (GPS), Global Navigation Satellite System (GLONASS), Galileo, and other similar GNSS systems. GNSSs may be affected by intentional or unintentional interference.

### SUMMARY

GNSS Spoofing is a technique where radio transmitters are used to send strong counterfeit GNSS signals with wrong position and/or timing information to deceive the GNSS receivers and make the GNSS receivers compute wrong position and/or time information. A challenge in GNSS spoofing detection is to determine whether the GNSS system is being spoofed or not because the spoofed signals are usually indistinguishable from the authentic signals in terms of frequency, code, and power. Moreover, a spoofing attack can be adaptive and dynamic, meaning that the attacker can adjust the spoofed signals according to feedback from the target receiver.

One of the challenges in GNSS spoofing detection is to find reliable reference signals that can be compared to received GNSS signals so that discrepancies can be identified. Existing spoofing detection techniques often use inertial sensors, antenna arrays, or alternative navigation systems to provide such a reference, but these systems and devices all have limitations in terms of availability and reliability.

This disclosure describes techniques to use data from an onboard weather radar as a reference signal for GNSS spoofing detection. Weather radars are a widely available and low-cost source of weather information that can provide accurate and timely measurements of atmospheric conditions and precipitation patterns. As will be explained in more detail below, weather radar may be used as a source for determining the authenticity of GNSS signals and as an alternate way to provide an appropriate location when GNSS is spoofed. Live weather data may be obtained by an aircraft from a satellite or ground service. A system of the present disclosure may determine a correlation between a first weather event (e.g., weather data from the satellite or ground service) and the second weather event (e.g., weather data from an onboard weather radar). For example, the system of the present disclosure may compare a position, size, shape, location or other such characteristic of a weather structure (e.g., hail, clouds, rain, icing, etc.) from the satellite or ground service with the weather data from an onboard weather radar.

The system may determine whether the correlation between the first weather event and the second weather event does not satisfy a threshold (e.g., the correlation is below a threshold), and output an alert if the correlation does not satisfy a threshold. For example, the system may then alert the aircraft when there is a difference in the position, size, shape, location or other such characteristic between the detected weather data and weather data received from the satellite or ground service because this presence of a difference may be a sign that a GNSS of the aircraft is being spoofed or is otherwise inaccurate. Thus, the techniques of this disclosure may enable GNSS spoofing detection even in scenarios where a spoofed signal is indistinguishable from an authentic signal.

According to an example of this disclosure, a computer-implemented method of detecting spoofing of a satellite-based navigation system in a vehicle, the method includes receiving, via a receiver device of the satellite-based navigation system, location data; determining an expected future location of the vehicle based on the location data; receiving, from an external computing device via a communication link, first weather data; determining, based on the first weather data, a first weather event for the expected future location; determining, based on second weather data received from a weather radar onboard the vehicle, a second weather event; determining a correlation between the first weather event and the second weather event; in response to the correlation between the first weather event and the second weather event failing to satisfy a threshold, and outputting an indication that the location data received by the receiver device of the satellite-based navigation system is inaccurate.

According to another example of this disclosure, a computing device for detecting spoofing of a satellite-based navigation system in a vehicle includes one or more memories and processing circuitry coupled to the one or more memories and configured to: receive, via a receiver device of the satellite-based navigation system, location data; determine an expected future location of the vehicle based on the location data; receive, from an external computing device via a communication link, first weather data; determine, based on the first weather data, a first weather event for the expected future location; determine, based on second weather data received from a weather radar onboard the vehicle, a second weather event; determine a correlation between the first weather event and the second weather event; in response to the correlation between the first weather event and the second weather event failing to satisfy a threshold, output an indication that the location data received by the receiver device of the satellite-based navigation system is inaccurate.

According to another example of this disclosure, a computer-readable storage medium stores instructions that when executed by one or more processors cause the one or more processors to receive, via a receiver device of a satellite-based navigation system in a vehicle, location data; determine an expected future location of the vehicle based on the location data; receive, from an external computing device via a communication link, first weather data; determine, based on the first weather data, a first weather event for the expected future location; determine, based on second weather data received from a weather radar onboard the vehicle, a second weather event; determine a correlation between the first weather event and the second weather event; and in response to the correlation between the first weather event and the second weather event failing to satisfy a threshold, and output an indication that the location data received by the receiver device of the satellite-based navigation system is inaccurate.

The details of one or more examples are set forth in the accompanying drawings and the description below. Other features, objects, and advantages will be apparent from the description, drawings, and claims.

### BRIEF DESCRIPTION OF DRAWINGS

FIG. 1A depicts a conceptual diagram of a vehicle equipped with an example global navigation satellite systems (GNSS) spoofing detection system, in accordance with one or mor examples of this disclosure.

FIG. 1B shows an example scenario where the vehicle of FIG. 1A is in flight in accordance with one or mor examples of this disclosure.

FIG. 2 depicts a conceptual diagram of a GNSS spoofing detection system.

FIG. 3 illustrates an example of an offboard computing system.

FIG. 4 illustrates an example of onboard computing system.

FIG. 5 is a flow diagram illustrating a process for performing GNSS spoofing detection in accordance with one or mor examples of this disclosure.

### DETAILED DESCRIPTION

Global navigation satellite systems (GNSSs) such as Global Positioning System (GPS) and Global Navigation Satellite System (GLONASS) and regional navigation satellite systems such as Indian Regional Navigation Satellite System (IRNSS) are satellite-based navigation systems that provide precise location and timing information to users. This technology has become an integral part of various sectors, including transportation, logistics, telecommunications, and emergency services. This reliance on satellite-based navigation systems, however, makes users of such systems susceptible to malicious activities such as spoofing and jamming.

GNSS Spoofing is a technique where radio transmitters are used to send strong counterfeit GNSS signals with wrong position and/or timing information to deceive the GNSS receivers and make them compute wrong position and/or time information. The main challenge in GNSS spoofing detection is to determine whether the GNSS system is being spoofed or not because the spoofed signals are usually indistinguishable from the authentic signals in terms of frequency, code, and power. Moreover, a spoofing attack can be adaptive and dynamic, meaning that the attacker can adjust the spoofed signals according to feedback from the target receiver. Therefore, conventional processes that rely on signal characteristics or receiver measurements may not be sufficient or robust enough to detect GNSS spoofing.

One of the challenges in GNSS spoofing detection is to find reliable reference signals that can be compared to received GNSS signals so that discrepancies can be identified. Existing spoofing detection techniques often use inertial sensors, antenna arrays, or alternative navigation systems to provide such a reference, but these systems and devices all have limitations in terms of availability and reliability. For example, in remote oceanic locations, alternative navigation systems may not be functional and flying by site may not be possible.

This disclosure describes techniques to use data from an onboard weather radar as a reference signal for GNSS spoofing detection. Weather radars are a widely available and low-cost source of weather information that can provide accurate and timely measurements of atmospheric conditions and precipitation patterns. As will be explained in more detail below, weather radar may be used as a source for determining the authenticity of GNSS signals and as an alternate way to provide an appropriate location when GNSS is spoofed. Live weather data may be obtained by an aircraft from a satellite or ground service. A system of the present disclosure may compare a position, size, shape, location or other such characteristic of a weather structure (e.g., hail, clouds, rain, icing, etc.) from the satellite or ground service with the weather data from an onboard weather radar. The system may then alert the aircraft when there is a difference in the position, size, shape, location or other such characteristic between the detected weather data and weather data received from the satellite or ground service because this presence of a difference may be a sign that a GNSS of the aircraft is being spoofed or is otherwise inaccurate. Thus, the techniques of this disclosure may enable GNSS spoofing detection even in scenarios where a spoofed signal is indistinguishable from an authentic signal.

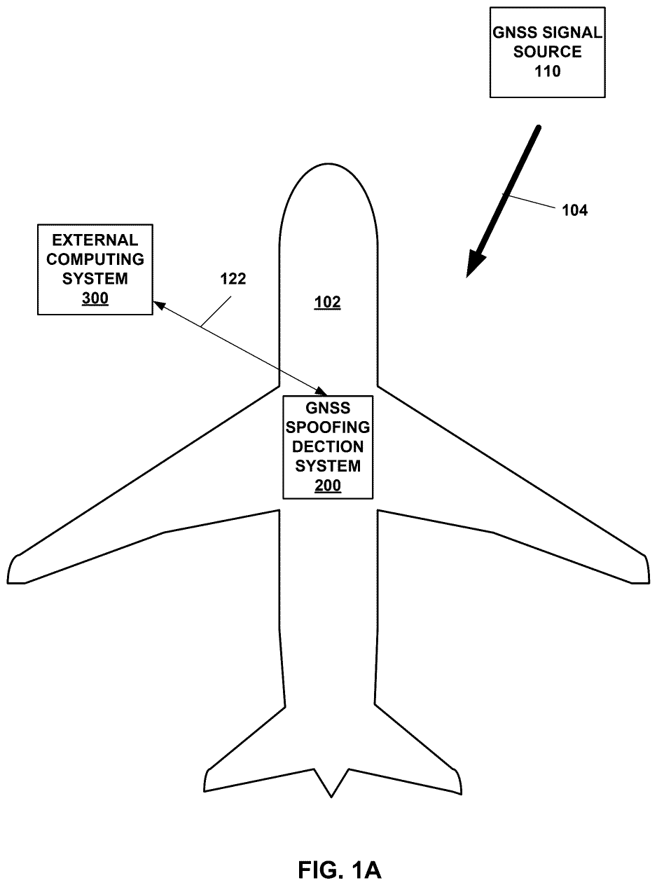

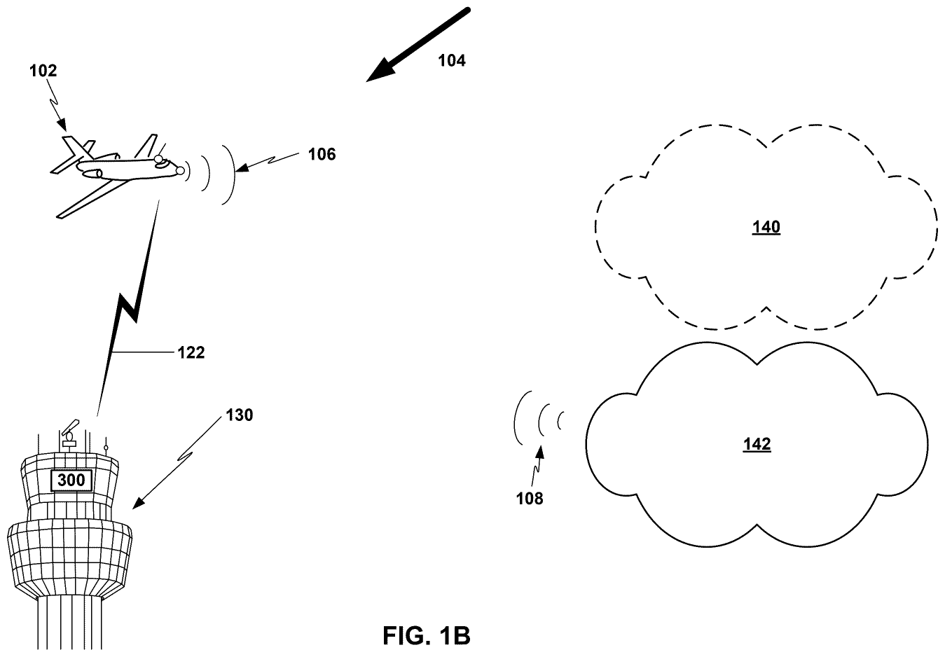

FIG. 1A depicts a conceptual diagram of a vehicle 102 equipped with an example GNSS spoofing detection system 200, in accordance with one or mor examples of this disclosure. In the example depicted in FIG. 1A, vehicle 102 is depicted as a fixed wing aircraft; however, the techniques of this disclosure may similarly be applicable to any other air vehicle, such as a helicopter or unmanned aerial vehicle (UAV). In this example, the GNSS spoofing detection system 200 is installed in vehicle 102 and is configured to receive GNSS signals 104, which include location data, from GNSS signal source 110 and is also configured to communicate with external computing system 300 via datalink 122.

FIG. 1B shows an example scenario where vehicle 102 is in flight, and external computing system 300 is located in a ground-based control tower 130. External computing system 300, however, may be located in a wide variety of different locations. In the example of FIG. 1B, GNSS spoofing detection system 200, onboard vehicle 102, receives GNSS signals 104, which include location data, from GNSS signal source 110. Based on the received location data, GNSS spoofing detection system 200 determines a current location for vehicle 102. Based on the current location and aircraft state parameters, such as speed, heading, and altitude, GNSS spoofing detection system 200 determines an expected future location of vehicle 102. The aircraft state parameters may be GNSS-derived, e.g., determined based on GNSS locations. GNSS spoofing detection system 200 may, for example, determine the future location to be a location where vehicle 102 is expected to be in a certain amount of time or after a certain distance travelled given the current location, speed, heading, and altitude of vehicle 102. If, for example, vehicle 102 is flying at 400 to 600 knots, then the future location may be 20 to 40 nautical miles in front of vehicle 102, which is where vehicle 102 is expected to be in 5 to 10 minutes depending on the speed of vehicle 102. In some examples, expected future locations closer than 20 nautical miles or farther than 40 nautical miles may be used.

GNSS spoofing detection system 200 receives, from external computing system 300, first weather data (i.e., received weather data) and determines, based on the received weather data, a first weather event for the expected future location. This first weather event is shown as weather structure 140 in FIG. 1B. External computing system 300 may, for example, store of otherwise obtain the first weather data for the expected future location from a weather source, such as air traffic control or a datalink weather service that aggregates weather data from multiple sources. The weather information may, for example, include information identifying the presence of rain, thunderstorms, ice crystals, hail, and other such meteorological phenomena.

GNSS spoofing detection system 200 receives second weather data from a weather radar onboard vehicle 102 and determines a second weather event based on the second weather radar data. This second weather event is shown as weather structure 142 in FIG. 1B. As will be explained in greater detail below, the weather radar onboard vehicle 102 may be configured to detect weather structures by transmitting radar signals 106, e.g., as radio waves, and receives reflected radar signals 108, which are reflections of those transmitted radio waves. The weather radar can then calculate the distance (range) and direction to weather structure 142 based on the time delay between transmission and reception.

GNSS spoofing detection system 200 determines a correlation between the first weather event and the second weather event. The spoofing detection performed by GNSS spoofing detection system 200 may be based on an assumption that if the GNSS signals are authentic and not spoofed, then the received weather data and the weather data obtained from the onboard weather radar both correspond to the same location, and thus the first weather event and the second weather event are going to be the same, meaning the correlation between the first weather event and the second weather event should be fairly high. Therefore, significant deviation or mismatch between the weather radar data and the received weather data may be a sign of a spoofing attack.

In response to the correlation between the first weather event and the second weather event failing to satisfy a threshold, GNSS spoofing detection system 200 outputs an indication that the location data received from GNSS signal source 110 is inaccurate, which may be an indication that GNSS signal source 110 is a potential spoofing attacker rather than a legitimate signal source. In this context, failing to satisfy a threshold generally means that there was less than a threshold amount of correlation. In response to the correlation between the first weather event and the second weather event being equal to or above a threshold, GNSS spoofing detection system 200 may be configured to output an indication that the location data received from GNSS signal source 110 has been validated as accurate and that GNSS signal source 110 is a legitimate source. In this context, GNSS signals 104 being accurate and GNSS signal source 110 being considered a legitimate source likely means that GNSS signal source 110 is a constellation of satellites of the GNSS. In some implementations, GNSS spoofing detection system 200 may be configured to only affirmatively generate an output in response to GNSS signal source 110 not being a legitimate source, meaning a lack of an output is the indication that the location data received from GNSS signal source 110 has been validated as accurate.

GNSS spoofing detection system 200 may, for example, be configured to determine the correlation between the first weather event and the second weather event by determining if the first weather event can be found in the weather radar data. For example, if the weather data received from external computing system 300 indicates that vehicle 102 is located 15 nautical miles away from a rainy area, then the weather radar data should detect the rain clouds at 15 nautical miles at the same bearing. If the weather radar does not detect any rain clouds at 15 nautical miles at the same bearing, then the correlation is low, meaning GNSS signals 104 may be spoofed.

GNSS spoofing detection system 200 may, for example, be configured to determine the correlation between the first weather event and the second weather event by determining a position of the first weather and a position of the second weather event and determining a difference between the position of the first weather event and the position of the second weather event. In this example, GNSS spoofing detection system 200 may determine that the first weather event is identifiable in the weather data obtained from the onboard radar, but the weather radar data may show the weather event at a different location relative to the aircraft. For example, referring back to FIG. 1B, the received weather data may indicate that weather structure 142 is located a position of 11 degrees North and 50 degrees East, but the weather data obtained from the onboard weather radar may indicate that the weather structure is located at 11.5 degrees North and 50 degrees East, e.g., at the location of weather structure 140. In another example, the received weather data may indicate that the first weather structure is located 15 nautical miles ahead of vehicle 102, but the weather data obtained from the onboard weather radar may only show a weather structure at 30 nautical miles ahead of vehicle 102. In response to these differences in locations exceeding a certain threshold, GNSS spoofing detection system 200 may be configured to determine that GNSS signals 104 are not authentic.

In some examples, the threshold may be that if the first weather structure and the second weather structure are more than a certain distance, such as 2 nautical miles apart, then GNSS spoofing detection system 200 identifies GNSS signals 104 as possibly being spoofed. In some examples, GNSS spoofing detection system 200 may utilize different thresholds depending on phase of flight or location. For example, if vehicle 102 is cruising over a remote oceanic area, then GNSS spoofing detection system 200 may use a larger threshold of 5 nautical miles, but if vehicle 102 is over a populated area or nearing take off and landing, then GNSS spoofing detection system 200 may use a smaller threshold of 5 nautical miles.

GNSS spoofing detection system 200 may, for example, be configured to determine the correlation between the first weather event and the second weather event by determining a shape and/or size of a first weather structure for the first weather and a shape and/or size of a second weather structure for the second weather event and determine a difference between the shape and/or size of the first weather event and the shape and/or size of the second weather event. For example, if the weather data received from external computing system 300 indicates that the first weather event is a large thunderstorm at the expected future location, then the weather radar data should detect a similarly sized thunderstorm. If the weather radar does not detect a similarly sized thunderstorm, then the correlation is low, meaning GNSS signals 104 may be spoofed.

GNSS spoofing detection system 200 may, for example, be configured to determine the correlation between the first weather event and the second weather event by determining an expected amount of reflectivity corresponding to the first weather event and an actual amount of reflectivity corresponding to the second weather event, and determining a difference between the expected amount of reflectivity and the actual amount of reflectivity. If a magnitude of the difference in reflectivity exceeds a certain threshold, then the correlation is low, meaning GNSS signals 104 may be spoofed. Differences between the expected amount of reflectivity corresponding to the first weather event and the actual amount of reflectivity corresponding to the second weather event may indicate that received weather data and the weather data obtained from the onboard radar correspond to different types of weather events, e.g., ice instead of rain.

Although the techniques of FIG. 1B have been described with respect to a single weather event or single weather structure, in some examples, GNSS spoofing detection system 200 may be configured to identify multiple weather events or multiple weather structures and use the multiple weather events or structures to determine the authenticity of GNSS signals. For example, vehicle 102 may include a wide

[symbol]

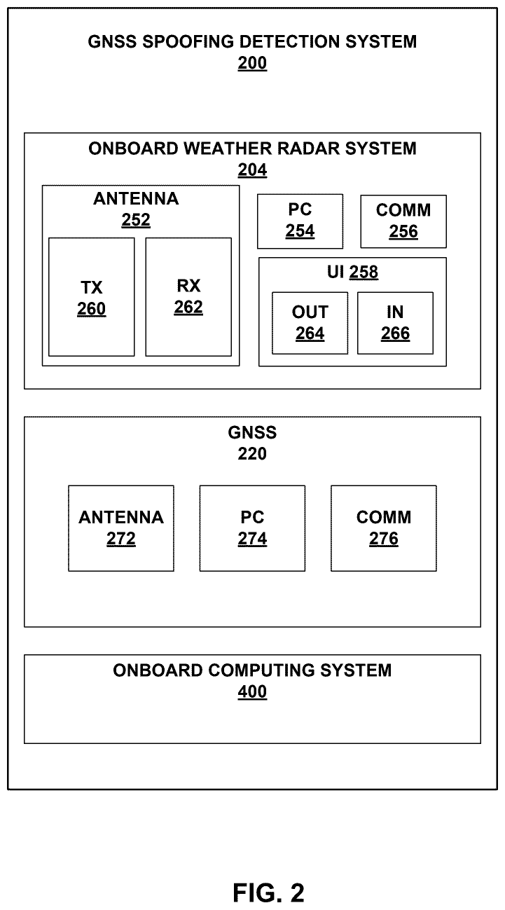

FIG. 2 depicts a conceptual diagram of GNSS spoofing detection system 200, which includes at least an onboard weather radar system 204, GNSS 214, and an onboard computing system 400. Weather radar system 204, GNSS 214, and onboard computing system 400 may be fully or partially integrated into a single coherent unit, or alternatively, may be two or more physically distinct units in data communication with one another.

Onboard weather radar system 204 may generally be any type of aircraft weather radar such as a pulse radar that uses short, high-powered pulses to detect precipitation by measures a time delay and intensity of reflected signals. In some examples, onboard weather radar 204 may be a doppler radar configured to measure both the intensity and velocity of precipitation particles and detect wind shear, turbulence, microbursts, and other such weather phenomena. On-board weather radar system 204 may be a multi-scan radar that uses multiple radar beams at different angles to scan various altitudes. On-board weather radar system 204 may be a mechanically scanning radar or a digitally scanning radar, such as a phased-array radar that uses electronically steered beams instead of mechanically moving antennas. In some examples, onboard weather radar 204 may be a forward-looking radar configured to determine predictive wind shear ahead of vehicle 102.

Regardless of what specific type of onboard weather radar system 204 is onboard, onboard weather radar system 204 may include an antenna 252, processing circuitry 254 (PC 254 in FIG. 2), data communication 256, and a user interface 258. Radar antenna 252 may be installed near the front of a vehicle, such as within the nose of vehicle 102, and includes transmission circuitry 260 configured to transmit a transmitted radar signal 206 (FIG. 1B). For example, transmission circuitry 260 may use the photoelectric effect, passing an electric current through a metal or other substance, causing the metal or other substance to emit photons of a given wavelength.

Radar antenna 252 includes receiving circuitry 262 configured to receive a reflected radar signals 208 (FIG. 1B). For example, receiving circuitry 262 may similarly use the photoelectric effect, such that it includes a metal or other substance that, when struck by photons of reflected radar signal 208, generate a characteristic electric current indicative of the reflected radar signals 108, which may then be interpreted as data by processing circuitry 254.

Processing circuitry 254 may receive a signal (e.g., data) indicative of reflected radar signals 108, and process the signal so as to determine one or more objects (e.g., obstructions or other obstacles) in the vicinity that would have caused the transmitted radar signal 106 to be reflected. For example, processing circuitry 254 may determine, based on reflected radar signals 108, the presence of an obstacle, such as a storm cell, in the flightpath of vehicle 102. In the example of FIG. 1B, weather structure 142 would be the object that caused the reflection.

Radar system UI 258 may be configured to display a graphical indication of potential obstacles in the vicinity of vehicle 102. For example, UI 258 may include an output device 264, such as a display screen, configured to output a graphical indication of one or more obstacles detected by reflected radar signals 108.

Onboard weather radar system 204 performs and processes weather radar scans. For example, weather radar system 204 may include at least a transmitter configured to emit a transmitted radar signal 106 and a receiver configured to detect a reflected radar signals 108. Onboard weather radar system 204 may include processing circuitry configured to identify, based on reflected signals 108, one or more obstacles surrounding vehicle 102, and output an indication of the obstacle(s) for display to a user, such as a pilot of vehicle 102. For example, weather radar system 204 may be configured to detect, based on reflected radar signals 108, an instance of inclement weather within a current intended flightpath of vehicle 102. For example, inclement weather may generally include any hazardous atmospheric disturbance, such as a storm cell, storm clouds, hail, rain, tornadoes, hurricanes, blizzards, strong headwinds, or turbulence.

Onboard weather radar system 204 may be configured to perform volume scanning by scanning the atmosphere at multiple elevation angles to collect data at different heights. Using the collected data, onboard weather radar system 204 may create a three-dimensional (3D) dataset of weather conditions to store in a 3D weather buffer. The 3D weather buffer is a digital representation of detected weather phenomena, stored in three dimensions (latitude, longitude, and altitude). The 3D weather provides a volumetric view of precipitation, storms, atmospheric conditions, and other such weather events. In this context, 3D refers to the fact that the weather data corresponds to a 3D volume of space and is not describing the actual storage media used to store the buffer.

GNSS 220 includes antenna 272, processing circuitry 274 and communications interfaces 276. Antenna 272 receives GNSS signals from a constellation of satellites orbiting the earth. Each satellite transmits a unique signal that includes information about its position and the exact time the signal was sent. Antennas 272 may, for example, receive the signals in L-band frequencies (e.g., L1, L2, L5) and perform filtering and low-noise amplification (LNA) to improve signal quality.

Processing circuitry 274 utilizes signals received from multiple satellites to determine the precise location of a vehicle. Processing circuitry 274 can calculate the time it takes for each signal to travel from the satellite to the vehicle by comparing the time the signal was sent, as encoded in the signal, with the time the signal was received. Using this time difference and the known speed of light, processing circuitry 274 determines the distance from each satellite to the vehicle. To accurately determine the location of the vehicle, processing circuitry 274 may use signals from multiple, such as at least four, satellites. Processing circuitry 274 uses the distances from these satellites to perform a process called trilateration. By calculating where the spheres (each with a radius equal to the distance from a satellite) intersect, the exact position of the vehicle can be determined in three-dimensional space. Processing circuitry 274 may also be configured to account for various sources of error, such as atmospheric conditions, satellite clock errors, and signal multipath effects and apply corrections to improve the accuracy of the location determination. Once the location is calculated, processing circuitry 274 may output, via communications interfaces 276, the position of the vehicle in terms of latitude, longitude, and altitude. This information can then be used for navigation and other applications, including the spoofing detection techniques described herein.

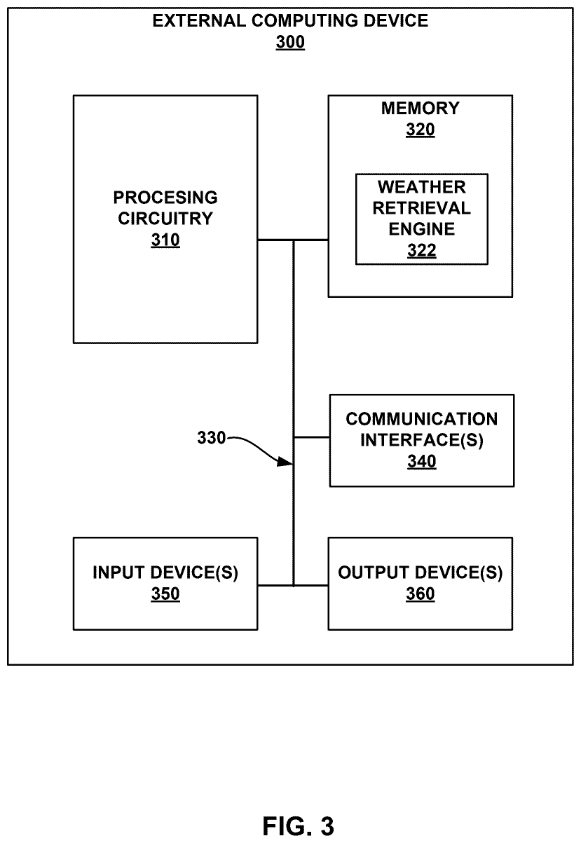

FIG. 3 illustrates an example of external computing system 300, which may be an offboard computing system, meaning the system is external to vehicle 102. External computing device 300 may, for example, be a computing device of or in communication with a ground-based weather source, such as the National Weather Service of the National Oceanic and Atmospheric Administration, the weather services of the Federal Aviation Administration (FAA), the United Kingdom Meteorological Office, the World Meteorological Organization (WMO), or any other such meteorological agency. External computing device 300 may additionally or alternatively retrieve weather data from other meteorological sources. In some implementations, external computing system 300 may be configured to retrieve data from multiple sources and prioritize the data, e.g., by newest to oldest, and determine the best data to send to onboard computing system 400. Additionally or alternatively, external computing system 300 may be configured to retrieve weather data from multiple sources and extrapolate the weather data from the multiple source into a more accurate weather prediction.

External computing system 300 represents generic computing hardware configured to store and execute weather retrieval engine 322. In the example of FIG. 3, offboard system 300 includes processing circuitry 310, memory 320, communication interface(s) 340, input device(s) 350, and output device(s). The aforementioned components of offboard system 300 may be connected to one another through a bus 330, which generally represents one or more busses and is intended to generically represent all the electrical and data connectivity of internal components included within offboard system 300.

Processing circuitry 310 implements the functionality of and/or executes the instructions associated with weather retrieval engine 322. Processing circuitry 310 may be implemented as any of a variety of suitable circuitry that includes a processing system, such as one or more integrated circuits, microprocessors, digital signal processors (DSPs), application specific integrated circuits (ASICs), field programmable gate arrays (FPGAs), discrete logic, software, hardware, firmware or any combinations thereof. When the techniques are implemented partially in software, offboard system 300 may store instructions for the software in a suitable, non-transitory computer-readable medium (e.g., memory 320) and execute the instructions in hardware using processing circuitry 310 to perform the techniques of this disclosure.

Memory 320 is intended to generically represent all memory included within offboard system 300. In some implementations, memory 320 may include a plurality of separate devices and memory units. Theses memory devices and memory units may include volatile memory, such as random access memory (RAM), and/or non-volatile memory, such as ROM and storage media. Example of RAM include dynamic random access memory (DRAM), including synchronous DRAM (SDRAM), magnetoresistive RAM (MRAM), resistive RAM (RRAM). Examples of storage media include solid-state storage media (e.g., solid state drives and/or removable flash memory), optical storage media (e.g., optical discs), and/or magnetic storage media (e.g., hard disk drives). Flight plan validation engine 322 may be stored in any volatile and/or non-volatile memory component of memory 320 and executed by processing circuitry 310.

Communication interface(s) 340 generally represents all hardware, e.g., transceiver circuitry, within offboard system 300 for communicating with external devices. Communication interface(s) 340 may facilitate communication with external devices via one or more wired and/or wireless network connections by transmitting and/or receiving signals on the one or more networks. Examples of communication interface(s) 340 include a network interface card (e.g., such as an Ethernet card or WiFi card), an optical transceiver, a radio frequency transceiver, or any other type of device that can send and/or receive information. Other examples of communication interface(s) 340 may include short wave radios, cellular data radios, wireless network radios, as well as USB controllers.

Offboard system 300 also includes input device(s) 350 (e.g., a keyboard, mouse, or touchscreen) and output device(s) 360 (e.g., a display, printer). The various examples of input and output devices listed above represent a non-exhaustive list of the types of the types of input and output devices that may be included in input device(s) 350 and output device(s) 360.

When processing circuitry 310 executes weather retrieval engine 322, then external computing device 300 may be configured to provide weather data for a future expected location to onboard computing system 400. For example, in response to receiving a request from onboard computing system 400 for weather data for the future expected location, processing circuitry 310 may retrieve weather data for the future expected location from a memory 320 or from another source via communication interfaces 340 and transmit retrieved weather data to onboard computing device 400.

Although offboard system 300 is shown in the example of FIG. 3 as being a single device, in many implementations, the functionality attributed to airline client system may be performed across multiple devices.

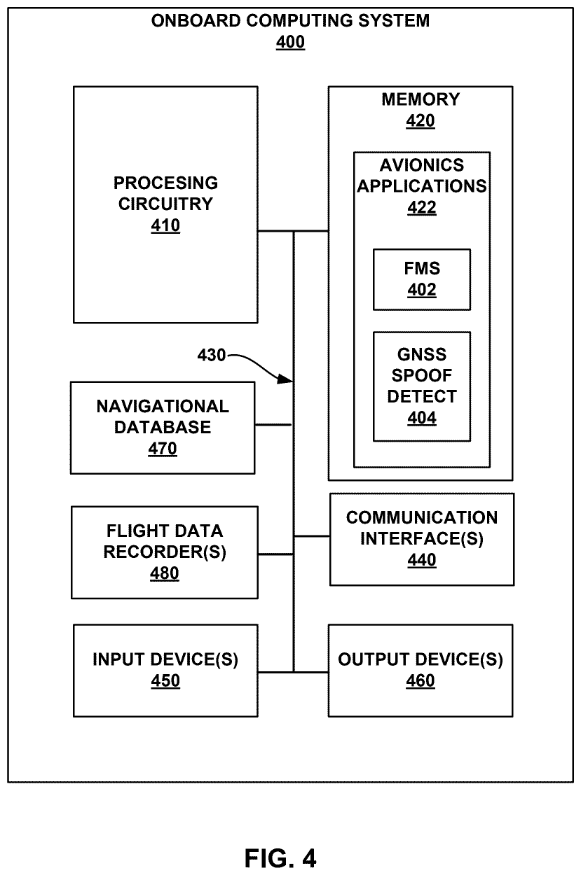

FIG. 4 illustrates an example of onboard computing system 400. In the example of FIG. 4, onboard computing system 400 is generally described as being the avionics of an aircraft. It should be understood, however, that functionality attributable to onboard computing system 400 may also be performed by other types of devices, including but not limited to an electronic flight bag in an aircraft, a controller of a UAV, or some other type of computing device onboard or offboard the aircraft. Onboard computing system 400 is specialized computing hardware configured to store and execute avionics applications. In the example of FIG. 4, onboard computing system 400 includes processing circuitry 410, memory 420 which stores avionics applications 422, communication interface(s) 440 to communicate with other devices, input device(s) 450, output device(s) 460, navigational database 470, and flight data recorder(s) 480. The aforementioned components of onboard computing system 400 may be connected to one another through a bus 430, which generally represents one or more busses and is intended to generically represent all the electrical and data connectivity of internal components included within onboard computing system 400.

Processing circuitry 410 implements the functionality of and/or executes the instructions associated with avionics applications 422. Processing circuitry 410 may be implemented as any of a variety of suitable circuitry that includes a processing system, such as one or more integrated circuits, microprocessors, digital signal processors (DSPs), application specific integrated circuits (ASICs), field programmable gate arrays (FPGAs), discrete logic, software, hardware, firmware or any combinations thereof. When the techniques are implemented partially in software, onboard computing system 400 may store instructions for the software in a suitable, non-transitory computer-readable medium (e.g., memory 420) and execute the instructions in hardware using processing circuitry 410 to perform the techniques of this disclosure.

Memory 420 is intended to generically represent all memory included within onboard computing system 400. In some implementations, memory 420 may include a plurality of separate devices and memory units. Theses memory devices and memory units may include volatile memory, such as RAM, and/or non-volatile memory, such as ROM and storage media. Example of RAM include DRAM, including SDRAM, MRAM, RRAM. Examples of storage media include solid-state storage media (e.g., solid state drives and/or removable flash memory), optical storage media (e.g., optical discs), and/or magnetic storage media (e.g., hard disk drives). The aforementioned avionics application (shown in FIG. 4 as avionics applications 422) may be stored in any volatile and/or non-volatile memory component of memory 420.

Communication interface(s) 440 generally represents all hardware e.g., transceiver circuitry, within onboard computing system 400 for communicating with external devices either on the ground or while in flight. Communication interface(s) 440 may facilitate communication with external devices via one or more wired and/or wireless network connections by transmitting and/or receiving signals on the one or more networks. Examples of communication interface(s) 440 include a network interface card (e.g. such as an Ethernet card), an optical transceiver, a radio frequency transceiver, a GPS receiver, or any other type of device that can send and/or receive information. Other examples of communication interface(s) 440 may include short wave radios, cellular data radios, wireless network radios, as well as USB controllers. Examples of communication interface(s) 440 for in-flight communication include a very high frequency (VHF) radio, a high frequency (HF) radio, or a satellite communication (SATCOM) radio.

Examples of communication interface(s) 440 used for data links include an aircraft communications addressing and reporting system (ACARS) for providing a digital data link system that allows for the exchange of messages between the aircraft and ground stations for purposes such as flight plan updates, weather information, and maintenance reports. Another examples of communication interface(s) 440 used for data links include controller-pilot data link communications (CPDLC) which allows air traffic control to send instructions and receive acknowledgments from pilots via text messages. Communications interface(s) 440 may also include an automatic dependent surveillance-broadcast transponder. The various examples of communications interfaces listed above represent a non-exhaustive list of the types of the types of communication interfaces that may be included in communication interface(s) 440.

Onboard computing system 400 also includes input device(s) 450 and output device(s) 460. Examples of input device(s) 450 include control display units (CDUs) with alphanumeric keypads or touchscreens to enter flight plans, waypoints, and other necessary data. Input device(s) 450 may also include an FMS control panel for entering information to the FMS, such as route, altitude, and speed using dedicated buttons, knobs, and touchscreen interfaces. Input device(s) 450 may also include yoke or sidestick controls as well as touchscreen interfaces. Input device(s) 450 may also include rotary knobs for setting values for altitudes, speeds, and other parameters and toggle switches for selecting modes or turning systems on and off.

Examples of output device(s) 460 may include an electronic flight instrument display to provide visual representations of flight data, including altitude, airspeed, heading, and attitude. Output device(s) 460 may also include a Heads-Up Display (HUD) that projects critical flight information onto a transparent screen in the pilot's line of sight or other cockpit displays to show navigation maps, engine parameters, system statuses, and the like. Output device(s) 460 may also include engine instrumentation displays to display data on engine performance, such as temperature, pressure, and revolutions per minute (RPMs). Output device(s) 460 may also include audio panels to relay communication from radios and alerts from systems to the cockpit. Output device(s) 460 may also include an FMS display to show flight plan information and performance data, as well as a traffic collision avoidance system (TCAS) display to alert pilots to nearby aircraft and potential collision threats.

The various examples of input and output devices listed above represent a non-exhaustive list of the types of the types of input and output devices that may be included in input device(s) 450 and output device(s) 460. Additionally, input and output functionality of onboard computing system 400 may facilitated by external devices that are separate from input device(s) 450 and output device(s) 460. For example, an EFB may be configured to input data to and output data for onboard computing system 400.

Avionics applications 422 represent a suite of software tools that may be used by a pilot in managing flight operations and managing the aircraft while in flight. Avionics applications 422 includes flight management system (FMS) 402 as well as other applications for communication, navigation, and monitoring within an aircraft. FMS 402 may be configured to generate a flight plan and navigate an aircraft through the flight plan. A flight plan may, for example, include a departure location, destination location, a departure time, a desired arrival time, a desired flight duration, a desired altitude, a set of waypoints, an identification of weather structures to be avoided, a fuel load for the aircraft, a number of passengers on the aircraft, a desired speed, an identification of a runway, or other such flight-related information. Based on feedback from various navigation sensors on the aircraft, FMS 402 may ensure that the aircraft is adhering to the flight plan. In this regard, FMS 402 may be viewed as the custodian of the flight plan.

Avionics applications 422 may also include a GNSS spoof detection application 404, which configures onboard computing system 400 to perform the techniques of this disclosure.

Avionics applications 422, for example, may also include applications for processing and displaying weather radar data and presenting essential flight information such as altitude, airspeed, attitude, and heading to a pilot. Avionics applications 422 also include various safety applications related to surveillance systems (e.g., transponders to communicate the aircraft's identity and altitude to air traffic control and other aircraft, such as automatic dependent surveillance-broadcast (ADS-B) systems that provide real-time data to air traffic control and other aircraft). Avionics applications 422 may also include the software to manage various emergency systems (e.g., an emergency locator transmitter, flight data recorder, and cockpit voice recorder) and cabin management systems (e.g., passenger infotainment systems and environmental control systems).

Navigational database 470 represents a specialized database that stores information needed by FMS 402 for the navigation and operation of an aircraft for purposes such as flight planning, route management, and ensuring safe navigation throughout a flight. Navigational database 470 may, for example, store waypoints, airways, navigational aids, airport information, standard instrument departures (SIDs) and standard terminal arrival routes (STARs), route data, and flight plans. The waypoints represent information on predefined geographical locations used for navigation, including both en-route waypoints and arrival/departure waypoints. The airways are data defining structured flight paths in the sky, including various air routes and connecting points. The navigational aids may, for example, be information on radio beacons, such as VHF Omnidirectional Range and Instrument Landing Systems that assist pilots in navigation. The airport information may, for example, include details about airports, including runway configurations, elevation, communications frequencies, and available approaches. SIDs and STARs may provide standardized paths for departures and arrivals. The route data may, for example, include information on preferred routes, including distance and estimated times. The flight data may be data regarding planned routes, altitudes, and waypoints for a specific flight. The locations of waypoints, airports, and navigational aids may, for example, be defined by geographical coordinates.

Navigational database 470 may also store information related to restrictions and procedures, performance data, and weather information. The restrictions and procedures may include airspace restrictions, no-fly zones, and specific procedures that need to be followed during flight. The performance data may include information related to aircraft performance, including altitude constraints, and speed limits. The weather information may include relevant meteorological data that might affect flight paths, such as wind patterns or turbulence zones. Navigational database 470 may be regularly updated to reflect changes in air traffic regulations, airport information, and navigational aids to ensure pilots have current information for safe and efficient flight operations.

Although not explicitly shown in FIG. 4, onboard computing system 400 may include or be in communication with numerous other hardware components or hardware systems, such as a global positioning system (GPS) receiver, an inertial navigation system (INS) that includes gyroscopes and accelerometers to calculate position based on movement, weather radar for detecting weather patterns, engine monitoring systems, aircraft data recording systems, flight data recording systems, and other such systems. In some examples, onboard computing system 400 may be configured to utilize inputs from a variety of specialized sensors such as altitude sensors, airspeed sensors, attitude sensors, heading sensors, GPS sensors, temperature sensors, pressure sensors, fuel sensors, weight and balance sensors, navigation sensors, environmental sensors, collision avoidance sensors, and other such sensors.

Flight data recorder(s) 480 may be configured to record, and store in memory 420, flight data 482. In some examples, flight data recorder(s) 480 may have dedicated memory, meaning the memory that stores flight data 482 is separate than, for example, the memory that stores avionics applications 422. Flight data recorder(s) 480 may include any combination of one or more flight data recorders including a quick access recorder, a deployable recorder, or a combined cockpit voice recorder and flight data recorder.

Flight data recorder(s) 480 may be configured to record flight dynamics and motion data. For example, flight data recorder(s) 480 may be configured to record the aircraft's altitude above sea level (i.e., altitude), the aircraft's speed relative to the surrounding air (i.e., airspeed), the aircraft's rate of ascent or descent (i.e., vertical speed), the direction the aircraft is pointed (i.e., heading), the aircraft's nose angle up/down and bank angle left/right (i.e., pitch and roll), the aircraft's deviation from a straight path or wind drift (i.e., yaw), and the aircraft's lateral, vertical, and longitudinal acceleration.

Flight data recorder(s) 480 may also be configured to record control surfaces and positioning data. For example, flight data recorder(s) 480 may be configured to record the aircraft's aileron position for controlling roll, the aircraft's elevator position for controlling pitch, the aircraft's rudder position for controlling yaw, the aircraft's flap positions for controlling changes in lift and drag (e.g., during takeoff, landing, and approach), the aircraft's spoiler positions for reducing lift and slowing the aircraft down, or the aircraft's slat positions for providing added lift during low-speed operations.

Flight data recorder(s) 480 may also be configured to record environmental conditions data. For example, flight data recorder(s) 480 may be configured to record outside air temperature, the presence of ice on wings or other critical surfaces, storm and weather information, and wind speed and direction.

Flight data recorder(s) 480 may also be configured to record flight path and navigation data, such as GPS position (e.g., latitude, longitude, and altitude coordinates), horizontal track and descent/ascent angles (i.e., flight path angle and track), speed relative to the ground (i.e., groundspeed), and navigation waypoints in the flight plan.

Flight data recorder(s) 480 may also be configured to record crew inputs. For example, flight data recorder(s) 480 may be configured to record control inputs, such as a pilot's inputs on yoke/stick, rudder pedals, and throttle. Flight data recorder(s) 480 may also be configured to record status or positions of switches (e.g., fuel pumps, anti-ice). Flight data recorder(s) 480 may also be configured to record communication controls, such as transponder codes, frequency changes, and communications status.

When processing circuitry 410 executes GNSS spoof detection application 404, onboard computing system 400 may be configured to perform the techniques of this disclosure. For example, receive, from GNSS 202 via communication interfaces 440, location data. The location data may either be in the form of a current location determined by GNSS 202 or other data extracted from GNSS signals, from which processing circuitry 410 can determine the current location. Processing circuitry 410 may determine an expected future location of the vehicle based on the location data received, from an external computing device via communication interfaces 440, first weather data. Processing circuitry 410 may determine, based on the first weather data, a first weather event for the expected future location and determine, based on second weather data received from onboard weather radar system 204, a second weather event. Processing circuitry 410 may determine a correlation between the first weather event and the second weather event, and in response to the correlation between the first weather event and the second weather event being below a threshold, output, via either output devices 460 or communications interfaces 440, an indication that the location data received by the receiver device of the satellite-based navigation system is inaccurate.

In response to the location data being inaccurate, processing circuitry 410 may also be configured to output one or more notifications to a pilot of the vehicle. For example,

In response to the data being inaccurate, processing circuitry 410 may also be configured to perform one or more automated actions. For example, processing circuitry 410 may alter a flight path being flown by FMS 402 or disabling certain systems or subsystems of an aircraft. Processing circuitry 410 may also invoke alternative navigation systems to control the aircraft. For example, if the received GNSS data is determined to be spoofed, then processing circuitry 410 may invoke ground-based navigation instruments, such as a VHF Omnidirectional Range VOR) receiver to detects signals from VOR stations to determine the aircraft's bearing relative to the station, distance measure equipment to measures the aircraft's distance from a ground-based station using radio signals, and instrument landing system receiver to help a pilot perform a precision landings using localizer (horizontal guidance) and glideslope (vertical guidance) signals, or an automatic direction finder to use signals from Non-Directional Beacons (NDBs) to provide bearing information relative to a station. Examples of onboard navigation instruments include an inertial navigation system to use gyroscopes and accelerometers to calculate aircraft position without external signals, gyroscopic compass to provide heading information, a magnetic compass to determine a direction relative to the Earth's magnetic field, and air data instruments, such as an airspeed indicator, altimeter, or vertical speed indicator, to perform dead reckoning navigation by measuring air pressure and velocity.

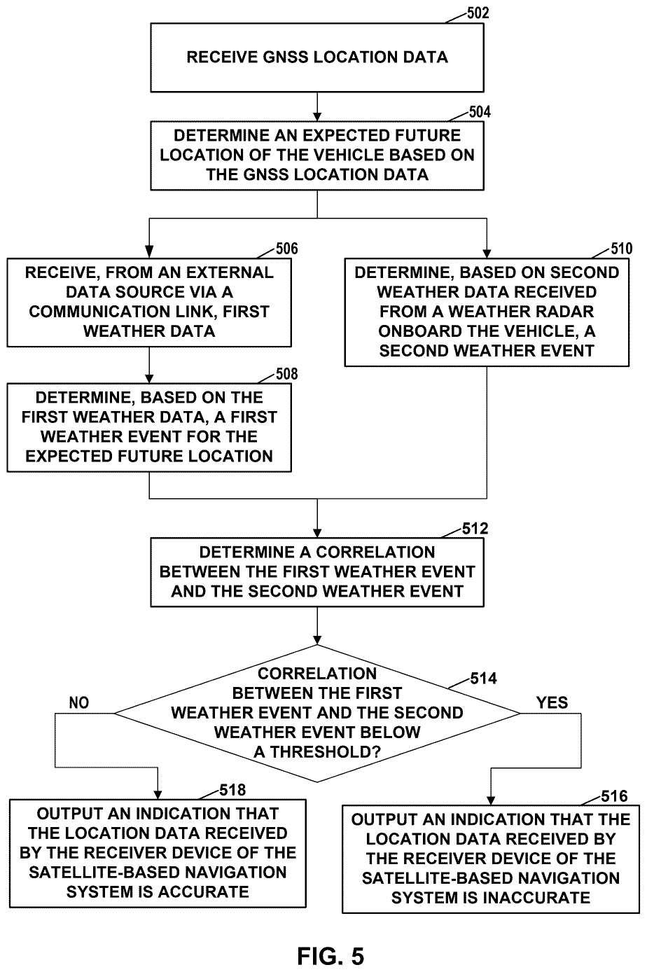

FIG. 5 is a flow diagram illustrating a process for performing GNSS spoofing detection in accordance with one or mor techniques of this disclosure. The process of FIG. 5 will be described with respect to GNSS spoofing detection system 200 of vehicle 102, although the techniques may also be performed by other devices or systems.

Receiving circuitry 262 of radar antenna 252 includes receives GNSS location data (502). The GNSS location data may be in the form of a plurality of GNSS signals from multiple GNSS satellites. Processing circuity 274 of GNSS 220 may determine a current location of vehicle 102 based on the GNSS signals, and communications interfaces 276 may transmit the current location to onboard computing system 400.

Processing circuitry 410 of onboard computing system 400 determines an expected future location of the vehicle based on the GNSS location data (504). Processing circuitry 410 may, for example, determine the expected future location of the vehicle further based on a current location of the vehicle, a speed of the vehicle, a heading of the vehicle, and an altitude of the vehicle.

Processing circuitry 410 receives, via a communication link from an external data source, such as external computing system 300, first weather data (506). Processing circuitry 410 determines, based on the first weather data, a first weather event for the expected future location (508). Processing circuitry 410 may, for example, transmit the expected future location, or data for determining the expected future location, to external computing system 300 and in response receive the first weather data from the external computing device. The first weather data may be weather data retrieved by external computing system 300 for the expected future location.

Processing circuitry 410 determines, based on second weather data received from a weather radar onboard the vehicle, a second weather event (510). Processing circuitry 410 may, for example, determine a distance between the current location and the expected future location; determine a second location based on the distance; and determine the second weather event for the second location.

Processing circuitry 410 determines a correlation between the first weather event and the second weather event (512). In some examples, to determine the correlation between the first weather event and the second weather event, processing circuitry 410 may be configured to determine a position of the first weather event relative to the vehicle; determine a position of the second weather event relative to the vehicle; and determine a difference between the position of the first weather event and the position of the second weather event. In some examples, to determine the correlation between the first weather event and the second weather event, processing circuitry 410 may be configured to determine an expected amount of reflectivity corresponding to the first weather event; determine an actual amount of reflectivity corresponding to the second weather event; and determine a difference between the expected amount of reflectivity and the actual amount of reflectivity. In some examples, to determine the correlation between the first weather event and the second weather event, processing circuitry 410 may be configured to determine a size of a first weather structure corresponding the first weather event; determine a size of a second weather structure corresponding the second weather event; and determine a difference between the size of the first weather structure corresponding the first weather event and the size of the second weather structure corresponding the second weather event. In some examples, to determine the correlation between the first weather event and the second weather event, processing circuitry 410 may be configured to determine a shape of a first weather structure corresponding the first weather event; determine a shape of a second weather structure corresponding the second weather event; and determine a difference between the shape of the first weather structure corresponding the first weather event and the shape of the second weather structure corresponding the second weather event.

In response to the correlation between the first weather event and the second weather event being below a threshold (514, yes), output an indication that the location data received by the receiver device of the satellite-based navigation system is inaccurate (516). In some examples, onboard computing system 400 may perform an action in response to the correlation between the first weather event and the second weather event being below a threshold. The action may, for example, include any one or more of disabling a GNSS-based navigation system on vehicle 102, enabling an alternate, e.g., not GNSS-based navigation system on vehicle 102, or disabling a system of subsystem of vehicle 102. In some instances, onboard computing system 400 may cause a flight plan being executed by FMS 402 to be altered. For example, if GNSSS spoofing detection system 200 detects the first weather event in a location different than location of the second weather event, then onboard computing system 400 may cause FMS 402 to alter a course of vehicle 102 towards the second weather event.

In the example described with respect to FIG. 5, if GNSS 220 receives authentic GNSS signals, then GNSS 220 can accurately determine the current location of the vehicle 102. If GNSS 220 determines the accurate current location of vehicle 102, then the expected future location and the second location should be approximately the same. If the expected future location and the second location are approximately the same, then the correlation between the first weather event and the second weather event should be high, as the first and the second weather event are the same weather event for the same location. If, however, GNSS 220 receives inauthentic GNSS signals, then GNSS 220 the current location determined for vehicle 102 will not correspond to the actual location of vehicle 102. If GNSS 220 does not determine the accurate current location of vehicle 102, then the expected future location and the second location will not be the same location. If the expected future location and the second location are not approximately the same location, then the correlation between the first weather event and the second weather event will be low, as the first and the second weather event will be different weather events at different locations.

In some implementations, GNSS spoofing detection system 200 may be configured to perform multiple iterations of the process of FIG. 5 before determining if GNSS signals are spoofed or not. That is, GNSS spoofing detection system 200 may be configured to detect multiple instances of the first weather event not correlating to the second weather event before outputting an indication that that location data received by the receiver device of the satellite-based navigation system is inaccurate.

Although the example of FIG. 5 has been described with respect to an onboard computing system, it should be understood that some or all of the techniques described with respect to FIG. 5 may also be performed by an external computer and transmitted back to vehicle 102. For example, in one implementation, onboard GNSS spoofing detection system 200 may be configured to transmit the location data (e.g., either the actual location data or location data derived from the actual location data) and the second weather data to an offboard computing device, i.e., a computing device not on vehicle 102, and the offboard computing device may be configured to do some or all of determining the expected future location of the vehicle based on the location data, receiving the first weather data, determining the first weather event, determining the second weather event, determining the correlation between the first weather event and the second weather event and outputting the indication that the location data received by the receiver device of the satellite-based navigation system is inaccurate.

The following numbered clauses illustrate one or more aspects of the devices and techniques described in this disclosure.

Clause 1: A computer-implemented method of detecting spoofing of a satellite-based navigation system in a vehicle, the method comprising: receiving, via a receiver device for the satellite-based navigation system, location data; determining an expected future location of the vehicle based on the location data; receiving, from an external computing device via a communication link, first weather data; determining, based on the first weather data, a first weather event for the expected future location; determining, based on second weather data received from a weather radar onboard the vehicle, a second weather event; determining a correlation between the first weather event and the second weather event; and in response to the correlation between the first weather event and the second weather event being below a threshold, outputting an indication that the location data received by the receiver device of the satellite-based navigation system is inaccurate.

Clause 2: The method of clause 1, further comprising: determining the expected future location of the vehicle further based on a current location of the vehicle, a speed of the vehicle, a heading of the vehicle, and an altitude of the vehicle.

Clause 3: The method of clause 1 or 2, wherein determining the second weather event comprises: determining a current location of the vehicle based on the location data; determining a distance between the current location and the expected future location; determining a second location based on the distance; and determining the second weather event for the second location.

Clause 4: The method of any of clauses 1-3, wherein determining the correlation between the first weather event and the second weather event comprises: determining a position of the first weather event relative to the vehicle; determining a position of the second weather event relative to the vehicle; and determining a difference between the position of the first weather event and the position of the second weather event.

Clause 5: The method of any of clauses 1-4, wherein determining the correlation between the first weather event and the second weather event comprises: determining an expected amount of reflectivity corresponding to the first weather event; determining an actual amount of reflectivity corresponding to the second weather event; and determining a difference between the expected amount of reflectivity and the actual amount of reflectivity.

Clause 6: The method of any of clauses 1-5, wherein determining the correlation between the first weather event and the second weather event comprises: determining a size of a first weather structure corresponding the first weather event; determining a size of a second weather structure corresponding the second weather event; and determining a difference between the size of the first weather structure corresponding the first weather event and the size of the second weather structure corresponding the second weather event.

Clause 7: The method of any of clauses 1-6, wherein determining the correlation between the first weather event and the second weather event comprises: determining a shape of a first weather structure corresponding the first weather event; determining a shape of a second weather structure corresponding the second weather event; and determining a difference between the shape of the first weather structure corresponding the first weather event and the shape of the second weather structure corresponding the second weather event.

Clause 8: The method of any of clauses 1-7, further comprising: transmitting the expected future location of the vehicle to the external computing device; and receiving the first weather data from the external computing device in response to transmitting the expected future location of the vehicle to the external computing device.

Clause 9: The method of any of clauses 1-8, wherein receiving the location data comprises receiving a plurality of different signals from different satellites, and the method further comprises determining a current location of the vehicle based on data encoded in the plurality of different signals.

Clause 10: The method of any of clauses 1-9, wherein the satellite-based navigation system comprises the Global Positioning System.

Clause 11: A computing device for detecting spoofing of a satellite-based navigation system in a vehicle, the computing device comprising: one or more memories; and processing circuitry coupled to the one or more memories and configured to: receive, via a receiver device of the satellite-based navigation system, location data; determine an expected future location of the vehicle based on the location data; receive, from an external computing device via a communication link, first weather data; determine, based on the first weather data, a first weather event for the expected future location; determine, based on second weather data received from a weather radar onboard the vehicle, a second weather event; determine a correlation between the first weather event and the second weather event; and in response to the correlation between the first weather event and the second weather event being below a threshold, output an indication that the location data received by the receiver device of the satellite-based navigation system is inaccurate.

Clause 12: The computing device of clause 11, wherein the processing circuitry is further configured to: determine the expected future location of the vehicle further based on a current location of the vehicle, a speed of the vehicle, a heading of the vehicle, and an altitude of the vehicle.

Clause 13: The computing device of clause 11 or 12, wherein to determine the second weather event, the processing circuitry is further configured to: determine a current location of the vehicle based on the location data; determine a distance between the current location and the expected future location; determine a second location based on the distance; and determine the second weather event for the second location.

Clause 14: The computing device of any of clauses 11-13, wherein to determine the correlation between the first weather event and the second weather event, the processing circuitry is further configured to: determine a position of the first weather event relative to the vehicle; determine a position of the second weather event relative to the vehicle; and determine a difference between the position of the first weather event and the position of the second weather event.

Clause 15: The computing device of any of clauses 11-14, wherein to determine the correlation between the first weather event and the second weather event, the processing circuitry is further configured to: determine an expected amount of reflectivity corresponding to the first weather event; determine an actual amount of reflectivity corresponding to the second weather event; and determine a difference between the expected amount of reflectivity and the actual amount of reflectivity.

Clause 16: The computing device of any of clauses 11-15, wherein to determine the correlation between the first weather event and the second weather event, the processing circuitry is further configured to: determine a size of a first weather structure corresponding the first weather event; determine a size of a second weather structure corresponding the second weather event; and determine a difference between the size of the first weather structure corresponding the first weather event and the size of the second weather structure corresponding the second weather event.

Clause 17: The computing device of any of clauses 11-16, wherein to determine the correlation between the first weather event and the second weather event, the processing circuitry is further configured to: determine a shape of a first weather structure corresponding the first weather event; determine a shape of a second weather structure corresponding the second weather event; and determine a difference between the shape of the first weather structure corresponding the first weather event and the shape of the second weather structure corresponding the second weather event.

Clause 18: The computing device of any of clauses 11-17, wherein the processing circuitry is further configured to: transmit the expected future location of the vehicle to the external computing device; and receive the first weather data from the external computing device in response to transmitting the expected future location of the vehicle to the external computing device.

Clause 19: The computing device of any of clauses 11-18, wherein the computing device comprises avionics of the vehicle.

Clause 20: A computer-readable storage medium storing instructions that when executed by one or more processors cause the one or more processors to: receive, via a receiver device of a satellite-based navigation system in a vehicle, location data; determine an expected future location of the vehicle based on the location data; receive, from an external computing device via a communication link, first weather data; determine, based on the first weather data, a first weather event for the expected future location; determine, based on second weather data received from a weather radar onboard the vehicle, a second weather event; determine a correlation between the first weather event and the second weather event; and in response to the correlation between the first weather event and the second weather event being below a threshold, output an indication that the location data received by the receiver device of the satellite-based navigation system is inaccurate.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media may include one or more of RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. These and other examples are within the scope of the following claims.

What is claimed is:

1. A computer-implemented method of detecting spoofing of a satellite-based navigation system in a vehicle, the method comprising:
receiving, via a receiver device for the satellite-based navigation system, location data;
determining an expected future location of the vehicle based on the location data;
receiving, from an external computing device via a communication link, first weather data;
determining, based on the first weather data, a first weather event for the expected future location;
determining, based on second weather data received from a weather radar onboard the vehicle, a second weather event;
determining a correlation between the first weather event and the second weather event; and
in response to the correlation between the first weather event and the second weather event failing to satisfy a threshold, outputting an indication that the location data received by the receiver device of the satellite-based navigation system is inaccurate.

2. The method of claim 1, further comprising:
determining the expected future location of the vehicle further based on a current location of the vehicle, a speed of the vehicle, a heading of the vehicle, and an altitude of the vehicle.

3. The method of claim 1, wherein determining the second weather event comprises:
determining a current location of the vehicle based on the location data;
determining a distance between the current location and the expected future location;
determining a second location based on the distance; and
determining the second weather event for the second location.

4. The method of claim 1, wherein determining the correlation between the first weather event and the second weather event comprises:
determining a position of the first weather event relative to the vehicle;
determining a position of the second weather event relative to the vehicle; and
determining a difference between the position of the first weather event and the position of the second weather event.

5. The method of claim 1, wherein determining the correlation between the first weather event and the second weather event comprises:
determining an expected amount of reflectivity corresponding to the first weather event;
determining an actual amount of reflectivity corresponding to the second weather event; and
determining a difference between the expected amount of reflectivity and the actual amount of reflectivity.

6. The method of claim 1, wherein determining the correlation between the first weather event and the second weather event comprises:
determining a size of a first weather structure corresponding the first weather event;
determining a size of a second weather structure corresponding the second weather event; and
determining a difference between the size of the first weather structure corresponding the first weather event and the size of the second weather structure corresponding the second weather event.

7. The method of claim 1, wherein determining the correlation between the first weather event and the second weather event comprises:
determining a shape of a first weather structure corresponding the first weather event;
determining a shape of a second weather structure corresponding the second weather event; and
determining a difference between the shape of the first weather structure corresponding the first weather event and the shape of the second weather structure corresponding the second weather event.

8. The method of claim 1, further comprising:
transmitting the expected future location of the vehicle to the external computing device; and
wherein receiving the first weather data from the external computing device comprises receiving the first weather data from the external computing device in response to transmitting the expected future location of the vehicle to the external computing device.

9. The method of claim 1, wherein receiving the location data comprises receiving a plurality of different signals from different satellites, and the method further comprises determining a current location of the vehicle based on data encoded in the plurality of different signals.

10. The method of claim 1, wherein the satellite-based navigation system comprises the Global Positioning System.

11. A computing device for detecting spoofing of a satellite-based navigation system in a vehicle, the computing device comprising:
one or more memories; and
processing circuitry coupled to the one or more memories and configured to:
receive, via a receiver device of the satellite-based navigation system, location data;
determine an expected future location of the vehicle based on the location data;
receive, from an external computing device via a communication link, first weather data;
determine, based on the first weather data, a first weather event for the expected future location;
determine, based on second weather data received from a weather radar onboard the vehicle, a second weather event;
determine a correlation between the first weather event and the second weather event; and
in response to the correlation between the first weather event and the second weather event failing to satisfy a threshold, output an indication that the location data received by the receiver device of the satellite-based navigation system is inaccurate.

12. The computing device of claim 11, wherein the processing circuitry is further configured to:
determine the expected future location of the vehicle further based on a current location of the vehicle, a speed of the vehicle, a heading of the vehicle, and an altitude of the vehicle.

13. The computing device of claim 11, wherein to determine the second weather event, the processing circuitry is further configured to:
determine a current location of the vehicle based on the location data;
determine a distance between the current location and the expected future location;
determine a second location based on the distance; and
determine the second weather event for the second location.

14. The computing device of claim 11, wherein to determine the correlation between the first weather event and the second weather event, the processing circuitry is further configured to:
determine a position of the first weather event relative to the vehicle;
determine a position of the second weather event relative to the vehicle; and
determine a difference between the position of the first weather event and the position of the second weather event.

15. The computing device of claim 11, wherein to determine the correlation between the first weather event and the second weather event, the processing circuitry is further configured to:
determine an expected amount of reflectivity corresponding to the first weather event;
determine an actual amount of reflectivity corresponding to the second weather event; and
determine a difference between the expected amount of reflectivity and the actual amount of reflectivity.

16. The computing device of claim 11, wherein to determine the correlation between the first weather event and the second weather event, the processing circuitry is further configured to:
determine a size of a first weather structure corresponding the first weather event;
determine a size of a second weather structure corresponding the second weather event; and
determine a difference between the size of the first weather structure corresponding the first weather event and the size of the second weather structure corresponding the second weather event.

17. The computing device of claim 11, wherein to determine the correlation between the first weather event and the second weather event, the processing circuitry is further configured to:
determine a shape of a first weather structure corresponding the first weather event;
determine a shape of a second weather structure corresponding the second weather event; and
determine a difference between the shape of the first weather structure corresponding the first weather event and the shape of the second weather structure corresponding the second weather event.

18. The computing device of claim 11, wherein the processing circuitry is further configured to:
transmit the expected future location of the vehicle to the external computing device; and
receive the first weather data from the external computing device in response to transmitting the expected future location of the vehicle to the external computing device.

19. The computing device of claim 11, wherein the computing device comprises avionics of the vehicle.

20. A computer-readable storage medium storing instructions that when executed by one or more processors cause the one or more processors to:
receive, via a receiver device of a satellite-based navigation system in a vehicle, location data;
determine an expected future location of the vehicle based on the location data;
receive, from an external computing device via a communication link, first weather data;
determine, based on the first weather data, a first weather event for the expected future location;
determine, based on second weather data received from a weather radar onboard the vehicle, a second weather event;
determine a correlation between the first weather event and the second weather event; and
in response to the correlation between the first weather event and the second weather event failing to satisfy a threshold, output an indication that the location data received by the receiver device of the satellite-based navigation system is inaccurate.
